(19) United States
(12) Patent Application Publication
(10) Pub. No.: US 2018/0192804 A1
(43) Pub. Date: Jul. 12, 2018

(54) Foldable Container Sleeve

(71) Applicant: Chih-Hung Lin, Taichung City (TW)

(72) Inventor: Chih-Hung Lin, Taichung City (TW)

(21) Appl. No.: 15/399,830

(22) Filed: Jan. 6, 2017

(51) Int. Cl. A47G 23/02; B32B 27/06; B32B 5/18; B65D 81/38

(52) U.S. Cl. CPC A47G 23/0216; B32B 27/06; B32B 5/18; B32B 2439/00; A47G 23/0241; B32B 2323/043; B32B 2323/046; B65D 81/3876

(57) ABSTRACT

A foldable container sleeve adapted to sleeve around a container includes a sleeve body for sleeving around the container. The sleeve body includes an insulating layer for wrapping around and contacting the container, a laminating layer disposed along and connected to an exterior surface of the insulating layer, and a smooth layer disposed along and connected to an exterior surface of the laminating layer. The insulating layer is made of a polyethylene foam material, the laminating layer is made of a polyethylene material, and the smooth layer is made of a thermoplastic material.

### FIELD

The disclosure relates to a foldable container sleeve, more particularly to a foldable container sleeve that can be used repeatedly.

### BACKGROUND

Referring to FIG. 1, a conventional container sleeve 1 is formed by bending corrugated fiberboard, and overlapping and adhering two opposite ends of the corrugated fiberboard using an adhesive. The container sleeve 1 serves as a heat insulator disposed around the circumference of a container 90, and facilitates holding of the container 90.

However, in practice, the conventional container sleeve 1 still has disadvantages as shown below:

1) The corrugated fiberboard is required to have sufficient thickness to provide a desired effect of heat isolation, thereby resulting in an increase in manufacturing costs.

2) The corrugated fiberboard has a relatively coarse surface, which may feel uncomfortable to a user.

3) Images and text printed on the corrugated fiberboard have rather poor resolution, which adversely affects the aesthetic appearance of the container sleeve 1.

4) The container sleeve 1 has double thickness at the position where the two opposite ends of the corrugated paper overlap. As such, the container sleeve 1 is unable to tightly fit the circumference of the container 90, and therefore cannot have an optimal heat-insulation effect.

5) If contacted with liquid, the corrugated fiberboard is prone to be damaged, and thus, the container sleeve 1 cannot be kept in good shape and recycled.

### SUMMARY

Therefore, an object of the disclosure is to provide a foldable container sleeve that can alleviate at least one of the drawbacks of the prior art.

According to the disclosure, the foldable container sleeve includes a sleeve body that is adapted to sleeve around a container.

The sleeve body includes an insulating layer for wrapping around and contacting the container, a laminating layer disposed along and connected to an exterior surface of the insulating layer, and a smooth layer disposed along and connected to an exterior surface of the laminating layer. The insulating layer is made of a polyethylene foam material, the laminating layer is made of a polyethylene material, and the smooth layer is made of a thermoplastic material.

### BRIEF DESCRIPTION OF THE DRAWINGS

Other features and advantages of the disclosure will become apparent in the following detailed description of the embodiment(s) with reference to the accompanying drawings, of which:

FIG. 1 is a perspective view illustrating a conventional container sleeve;

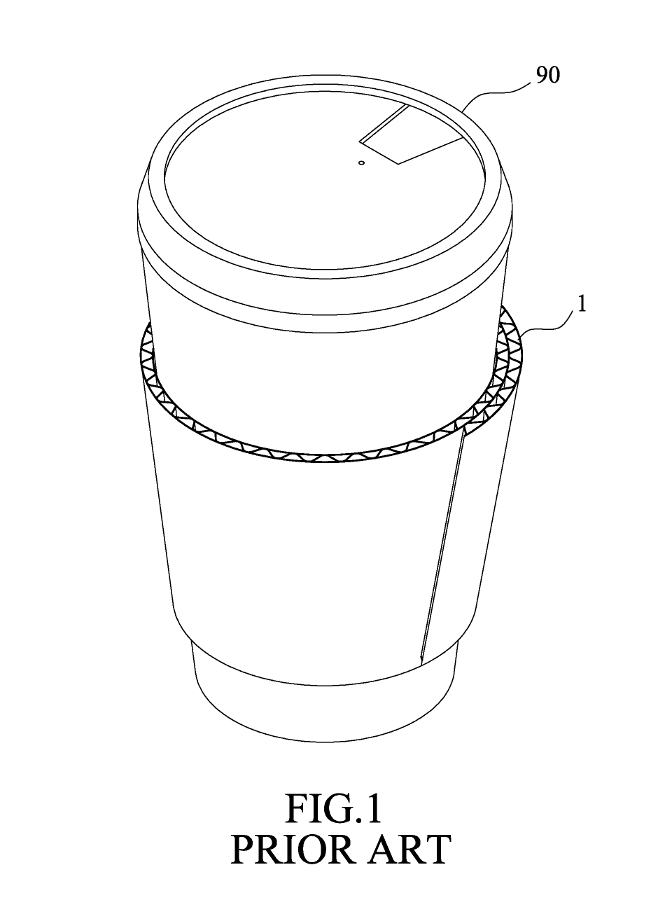

FIG. 2 is a perspective view illustrating a first embodiment of a foldable container sleeve according to the disclosure;

FIG. 3 is a sectional view taken along line III-III of FIG. 2;

FIG. 4 is a fragmentary enlarged sectional view illustrating a sleeve body of the first embodiment which includes an insulating layer, a laminating layer and a smooth layer in sequence; and

FIG. 5 is a perspective view illustrating a second embodiment of the foldable container sleeve according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

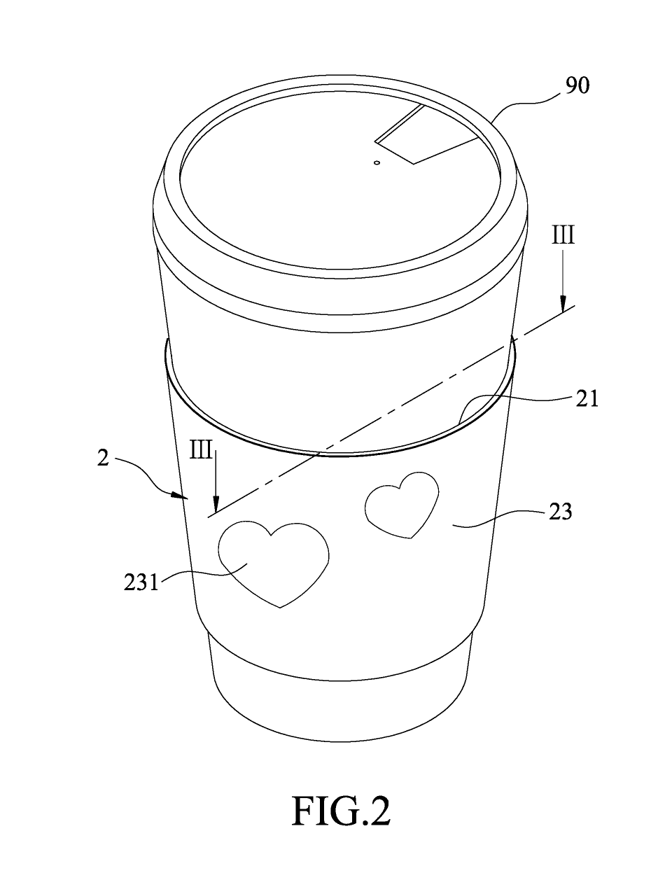

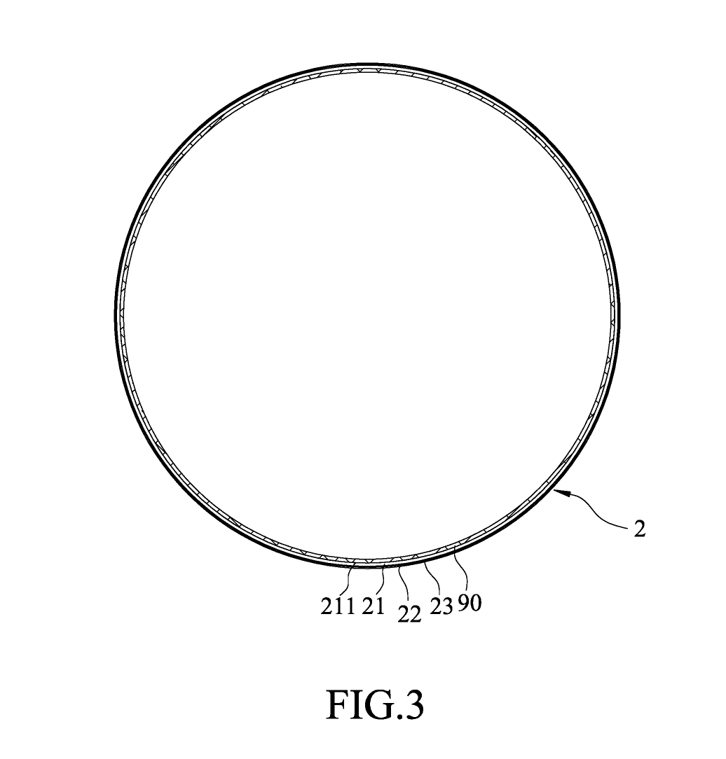

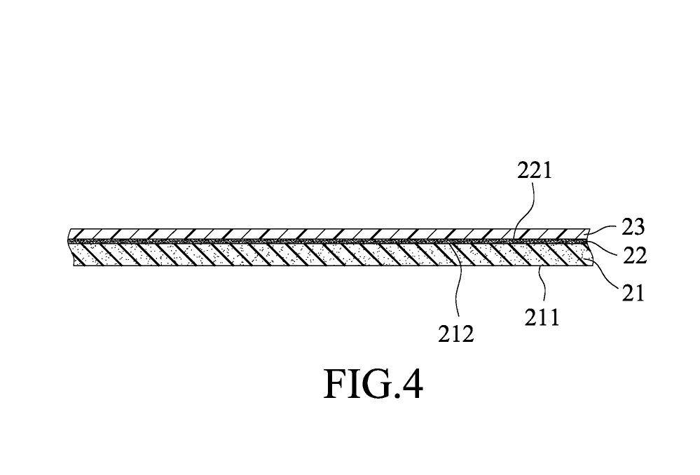

FIGS. 2 to 4 illustrate a first embodiment of a foldable container sleeve according to this disclosure which includes a sleeve body 2 which is adapted to sleeve around a container 90. In this embodiment, the container 90 is a beverage cup, and the foldable container sleeve is designed to have a truncated cone shape when expanded.

The sleeve body 2 includes an insulating layer 21 for wrapping around and contacting the container 90, a laminating layer 22 disposed along and connected to an exterior surface 212 of the insulating layer 21, and a smooth layer 23 disposed along and connected to an exterior surface 221 of the laminating layer 22. In this embodiment, as shown in FIG. 2, the insulating layer 21 has an inner surrounding surface 211 that is disposed opposite to the exterior surface 212 for wrapping around and contacting the container 90.

The insulating layer 21 is a foam layer and may be made of a polyethylene foam material. In certain embodiments, the insulating layer 21 has a thickness ranging from 1 mm to 10 mm. The thickness of the insulating layer 21 may vary based on actual requirements.

The laminating layer 22 is made of a polyethylene (PE) material. In certain embodiments, the laminating layer 22 is made of a low-density polyethylene (LDPE) material.

The smooth layer 23 is made of a thermoplastic material. To be specific, the smooth layer 23 is made of a material selected from the group consisting of a polyethylene material, a polypropylene (PP) material, a polyethylene terephthalate (PET) material, and combinations thereof. In this embodiment, the smooth layer 23 is made of a polyethylene material. The polyethylene material may be a high-density polyethylene material or a low-density polyethylene material. In certain embodiments, the smooth layer 23 has a thickness ranging from 0.01 mm to 0.2 mm.

The smooth layer 23 has a printing surface 231 disposed opposite to the laminating layer 22. It should be noted that, the printing surface 231 is smooth and may be printed with a pattern or logo with good resolution for advertising purposes.

Moreover, the smooth layer 23 may further include an anti-slip material or a pigment material.

During manufacturing of a laminate for manufacturing the sleeve body 2, the insulating layer 21 is provided, followed by the laminating layer 22 as an adhesive being formed on the exterior surface 212 of the insulating layer 21, after which the smooth layer 23 is formed on the exterior surface 221 of the laminating layer 22 and adhered to the insulating layer 21 through the laminating layer 22. The aforesaid method may be conducted by extrusion laminating techniques, dry laminating techniques or solvent-free laminating techniques. It should be noted that, in the embodiment where the insulating layer 21, the laminating layer 22 and the smooth layer 23 are all made of polyethylene materials, the foldable container sleeve of the disclosure may be recycled directly without an additional procedure for separating different materials.

Next, the laminate is cut to obtain a laminate unit having a predetermined shape in accordance with the shape of the container 90, and two opposite lateral ends of the laminate unit are connected using high frequency welding techniques so as to form the sleeve body 2 with a hollow shape, e.g., a truncated cone shape or a straight barrel shape. Finally, the sleeve body 2 is pressed and folded into a flat shape so as to complete the manufacturing process. It should be noted that, in this disclosure, the two opposite lateral ends are connected by directly contacting and bonding the lateral edges of the lateral ends with each other without overlapping one of the lateral ends on the other one of the lateral ends. In other words, the two opposite lateral ends are flush with each other, such that the inner surrounding surface 211 of the insulating layer 21 is a continuous planar surface. When in use, the sleeve body 2 of the foldable container sleeve is expanded and subsequently able to be sleeved around the container 90. Compared to the prior used corrugated fiberboard, the smooth layer 23 may provide a more comfortable feeling for a user. The insulating layer 21 may not only provide a heat insulating effect but may also prevent the hand of the user from directly contacting condensed water drops around the container 90 when the container 90 is used for containing a cold drink. Moreover, the foldable container sleeve is unlikely to be damaged by the water drops around the container 90 or liquid contained in the container 90, and may therefore be re-used.

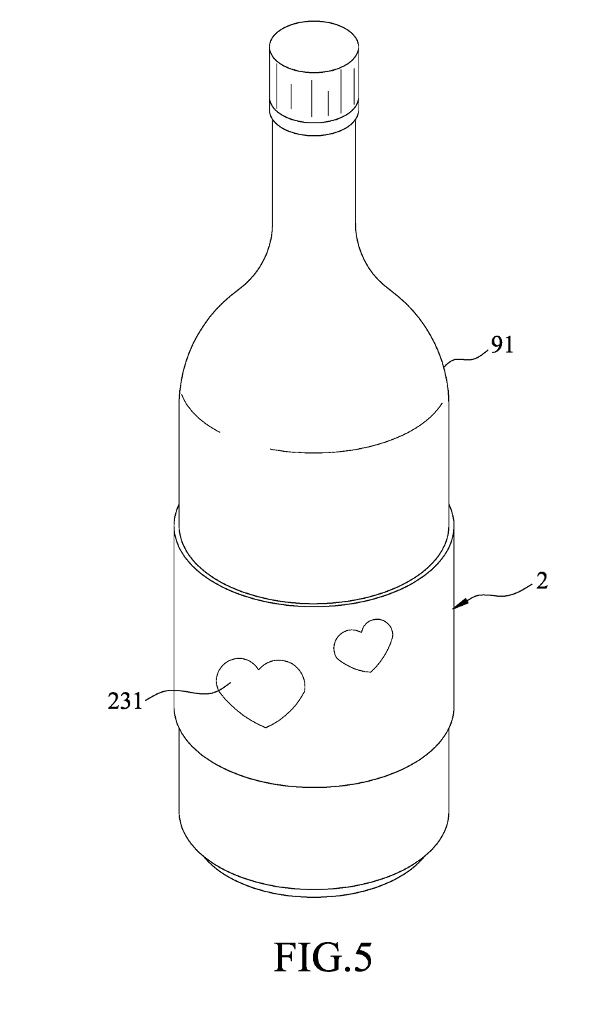

FIG. 5 illustrates a second embodiment of the foldable container sleeve according to the disclosure which is similar to the first embodiment expect for the shape. To be specific, the foldable container sleeve is used to sleeve around a bottle 91 and is designed to have a cylindrical straight barrel shape when being expanded. However, it should be noted that the shape of the foldable container sleeve may vary based on actual requirements.

In summary, the advantages of the foldable container sleeve of the disclosure are shown below:

1) When the insulating layer 21, the laminating layer 22 and the smooth layer 23 are all made of polyethylene materials, the foldable container sleeve may be recycled directly without an additional procedure for separating different materials.

2) The smooth layer 23 of the foldable container sleeve provides a more comfortable touch feeling for the user, and allows images and text printed thereon to have relatively high resolution.

3) The two opposite lateral ends of the laminate unit are flush with each other such that when the sleeve body 2 is expanded, the inner surrounding surface 211 of the insulating layer 21 may fittingly abut against an outer surrounding surface of the container 90, thereby improving heat and cold insulation and resulting in an increase in friction force between the container sleeve of this disclosure and the container 90.

4) The foldable container sleeve of the disclosure would not be easily damaged by the liquid contained in the container 90 and thus may be re-used.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A foldable container sleeve adapted to sleeve around a container, comprising:
a sleeve body for sleeving around the container, including
an insulating layer for wrapping around and contacting the container,
a laminating layer disposed along and connected to an exterior surface of said insulating layer, and
a smooth layer disposed along and connected to an exterior surface of said laminating layer,
wherein said insulating layer is made of a polyethylene foam material, said laminating layer is made of a polyethylene material, and said smooth layer is made of a thermoplastic material.

2. The container sleeve of claim 1, wherein said smooth layer is made of a material selected from the group consisting of a polyethylene material, a polypropylene material, a polyethylene terephthalate material, and combinations thereof.

3. The container sleeve of claim 2, wherein said polyethylene material of said smooth layer is a high-density polyethylene material.

4. The container sleeve of claim 2, wherein said polyethylene material of said smooth layer is a low-density polyethylene material.

5. The container sleeve of claim 2, wherein said laminating layer is made of a low-density polyethylene material.

6. The container sleeve of claim 5, wherein said insulating layer has an inner surrounding surface for wrapping around and contacting the container.

7. The container sleeve of claim 6, wherein said smooth layer has a printing surface disposed opposite to said laminating layer.

8. The container sleeve of claim 5, wherein said smooth layer has a printing surface disposed opposite to said laminating layer.
